(19) United States
(12) Patent Application Publication
(10) Pub. No.: US 2024/0322310 A1
(43) Pub. Date: Sep. 26, 2024

(54) BUTTON-TYPE SECONDARY BATTERY

(71) Applicant: LG ENERGY SOLUTION, LTD., Seoul (KR)

(72) Inventors: Sang Hak CHAE, Daejeon (KR); Young Ji TAE, Daejeon (KR); Joo Hwan SUNG, Daejeon (KR); Min Su CHO, Daejeon (KR); Geun Young PARK, Daejeon (KR); Min Gyu KIM, Daejeon (KR); Min Seon KIM, Daejeon (KR); Yeong Hun JUNG, Daejeon (KR); Min Young JU, Daejeon (KR)

(73) Assignee: LG ENERGY SOLUTION, LTD., Seoul (KR)

(21) Appl. No.: 18/577,238

(22) PCT Filed: Sep. 2, 2022
(86) PCT No.: PCT/KR2022/013226

§ 371 Date: Jan. 5, 2024

(30) Foreign Application Priority Data
Sep. 3, 2021 (KR) 10-2021-0117985

(51) Int. Cl. H01M 50/14; H01M 10/04; H01M 50/109; H01M 50/169; H01M 50/186; H01M 50/474; H01M 50/545; H01M 50/548

(52) U.S. Cl. CPC H01M 50/14; H01M 10/0431; H01M 50/109; H01M 50/169; H01M 50/186; H01M 50/474; H01M 50/545; H01M 50/548

(57) ABSTRACT

A button-type secondary battery may include: an electrode assembly; a can body housing the electrode assembly; a base plate including a through-hole and covering an opening at an upper end of the can body; an electrode terminal covering the through-hole of the base plate, at least a portion of the electrode terminal being inserted into the through-hole of the base plate; an insulating gasket configured to insulate the electrode terminal and the base plate from each other; and an insulating sheet disposed on a bottom surface of the base plate to insulate the bottom surface of the base plate. The electrode terminal may include: an insertion part inserted into the through-hole; and a terminal plate part extending outward from an upper end of the insertion part and having a plate shape, wherein the insertion part has a diameter that gradually increases in a direction toward the electrode assembly.

### CROSS-REFERENCE TO RELATED APPLICATION

The present application claims the benefit of the priority of Korean Patent Application 10-2021-0117985, filed on Sep. 3, 2021, which is hereby incorporated by reference in its entirety.

### TECHNICAL FIELD

The present invention relates to a button-type secondary battery, and more particularly, to a button-type secondary battery that is capable of preventing or minimizing damage and deformation of an electrode assembly inside a button cell, which may occur due to an impact and vibration outside the button cell.

### BACKGROUND ART

In recent years, the price of energy sources increases due to the depletion of fossil fuels, the interest in environmental pollution is amplified, and the demand for eco-friendly alternative energy sources is becoming an indispensable factor for future life. Accordingly, studies on various power generation technologies, such as solar power, wind power, and tidal power, are continuing, and power storage devices, such as batteries, for more efficiently using the generated electrical energy are also of great interest.

Furthermore, as technology development and demand for electronic mobile devices and electric vehicles using batteries increase, the demands for batteries as energy sources are rapidly increasing. Thus, many studies on batteries which are capable of meeting various demands have been conducted.

In particular, in terms of materials, there is a high demand for lithium secondary batteries, such as lithium ion batteries and lithium ion polymer batteries, having such advantages as high energy density, discharge voltage, and output stability.

The secondary batteries may be classified into, among others, cylindrical batteries and prismatic batteries, in which an electrode assembly is embedded in a cylindrical or prismatic metal can, and pouch-type batteries, in which an electrode assembly is embedded in a pouch-type case made of an aluminum laminate sheet, according to shapes of battery cases. In addition, recently, due to the trend of smaller wearable devices, the importance of developing small batteries such as button-type secondary batteries has been highlighted.

FIG. 1 is a perspective view of a button-type secondary battery according to a related art. FIG. 1 illustrates a shape in which the button-type secondary battery is damaged and deformed by an external impact or external force. In the button-type secondary battery 1, the electrode assembly 10 is embedded in a metal can body 20, and a metal base plate 30 covers an opening of the can body at an upper side. In addition, a metal electrode terminal 40 connected to an external electronic device is disposed at an upper center of the electrode assembly 10. The electrode terminal 40 and the base plate 30 are electrically insulated by an insulating gasket 50. As illustrated in FIG. 1, when external force or an external impact is applied to an upper portion of the button cell 1, the electrode terminal 40 is deformed downward, and a core is removed. As a result, since there is no support means that is capable of supporting a jelly roll-type electrode assembly 10 in which a central hole 15 is formed at a center thereof, there is a problem that the electrode assembly is deformed and collapsed downward in a wide range according to the deformation of the electrode terminal 40.

### DISCLOSURE OF THE INVENTION

### Technical Objective

The present invention has been devised to solve the above problem, and an object of the present invention is to provide a button-type secondary battery, and more particularly, to a button-type secondary battery that is capable of preventing or minimizing damage and deformation of an electrode assembly inside a button cell, which may occur due to an impact and vibration outside the button cell.

### Technical Solution

A button-type secondary battery according to the present invention relates to a button-type secondary battery having a diameter greater than a height thereof and includes an electrode assembly in which electrodes and separators are wound, a can body into which the electrode assembly is inserted, a base plate in which a through-hole is defined and which covers an opening of an upper end of the can body and is bonded to the can body, an electrode terminal of which at least a portion is inserted into the through-hole of the base plate and which covers the through-hole, an insulating gasket configured to insulate the electrode terminal and the base plate from each other, and an insulating sheet disposed on a bottom surface of the base plate to insulate the bottom surface of the base plate, wherein the electrode terminal includes an insertion part inserted into the through-hole and a terminal plate part extending outward from an upper end of the insertion part, wherein the terminal plate extends in the form of a plate, wherein the insertion part has a diameter that gradually increases in a direction closer to the electrode assembly.

An edge of the base plate and the opening of the can body may be bonded to each other by laser welding.

The electrode terminal, the insulating gasket, and the base plate may be bonded to each other through thermal fusion.

The insulating sheet may be attached to the bottom surface of the base plate.

A central hole may be defined in a winding center of the electrode assembly, and a bottom surface of the insertion part may have a diameter greater than that of the central hole.

A cross-section of the insertion part may have a trapezoidal shape, and the trapezoidal shape may have a lower side longer than an upper side thereof.

An area occupied by the central hole may be disposed within a range of an area occupied by a bottom surface of the insertion part, based on a plan view.

A diameter of a bottom surface of the insertion part may be greater 0.5 times or more to one time or less than a diameter of the electrode assembly.

The insulating sheet may have an insertion hole therein, and the insertion part may pass through the insertion hole of the insulating sheet.

A center pin filled in the central hole may be provided in the central hole.

A diameter of the bottom surface of the insertion part may be greater than a diameter of the center pin.

An area occupied by the center pin may be disposed within a range of an area occupied by the bottom surface of the insertion part, based on a plan view.

The bottom surface of the insertion part may have a diameter greater three times or more than a diameter of the center pin and equal to or less than a diameter of the electrode assembly.

The electrode terminal may have a positive pole, and each of the can body and the base plate may have a negative pole.

### Advantageous Effects

The button-type secondary battery according to the present invention relates to the button-type secondary battery of which the length of the diameter is greater than the height and which is capable of preventing or minimizing the damage and deformation of the electrode assembly inside the button cell, which may occur due to the impact and vibration outside the button cell.

### BRIEF DESCRIPTION OF THE DRAWINGS

FIG. 1 is a perspective view of a button-type secondary battery according to a related art.

FIG. 2 is a cross-sectional view of a button-type secondary battery according to Embodiment 1 of the present invention.

FIG. 3 is a cross-sectional view of a button-type secondary battery according to Embodiment 2 of the present invention.

### MODES FOR CARRYING OUT THE INVENTION

Hereinafter, preferred example embodiments of the present invention will be described in detail with reference to the accompanying drawings so that those of ordinary skill in the art can easily carry out the present invention. However, the present invention may be implemented in several different forms and is not limited or restricted by the following examples.

In order to clearly explain the present invention, detailed descriptions of portions that are irrelevant to the description or related known technologies that may unnecessarily obscure the gist of the present invention have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

### Embodiment 1

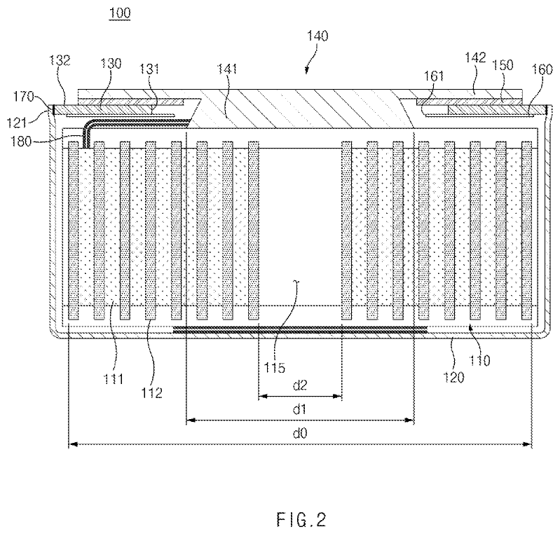

FIG. 2 is a cross-sectional view of a button-type secondary battery according to Embodiment 1 of the present invention.

With reference to FIG. 2, a button-type secondary battery 100 according to Embodiment 1 of the present invention may be a button-type secondary battery 100 of which a diameter is greater than a height. Also, the button-type secondary battery 100 according to Embodiment 1 of the present invention may include an electrode assembly 110, a can body 120, a base plate 130, an electrode terminal 140, an insulating gasket 150, and an insulating sheet 160.

The electrode assembly 110 may be formed by alternately disposing a positive electrode, a separator, and a negative electrode. The electrode assembly 110 may be a jelly roll-type electrode assembly 110 in which the electrodes and the separator are alternately disposed and wound. The electrode assembly 110 may be an electrode wound body in which one or more positive electrodes, one or more negative electrodes, and one or more separators are wound on each other.

The can body 120 may have a configuration in which the electrode assembly 110 is inserted. The can body 120 may have an internal space, and the electrode assembly 110 may be vertically inserted into the internal space. The vertical insertion may mean that the electrode assembly 110 is inserted so that a winding axis of the electrode assembly is perpendicular to a bottom part of the can body 120. The can body 120 may have an opening at an upper side thereof. That is, the can body 120 may be opened upward and include a bottom part and a sidewall.

The base plate 130 may cover an upper opening 121 of the can body 120 and be bonded to the can body 120. This bonding may be bonding using welding. Particularly, an edge 132 of the base plate and the opening 121 of the can body may be bonded to each other by laser welding. A portion at which the edge 132 of the base plate and the opening 121 of the can body are welded by welding may be a welding part 170.

Also, this type of laser welding may be seam welding that is advantageous for preventing a welding pin hole. In addition, a through-hole 131 may be formed in an inner center of the base plate 130. Here, the base plate may be made of a metal material, and the metal material may be at least one or more selected from SUS, nickel-plated carbon steel, and Al.

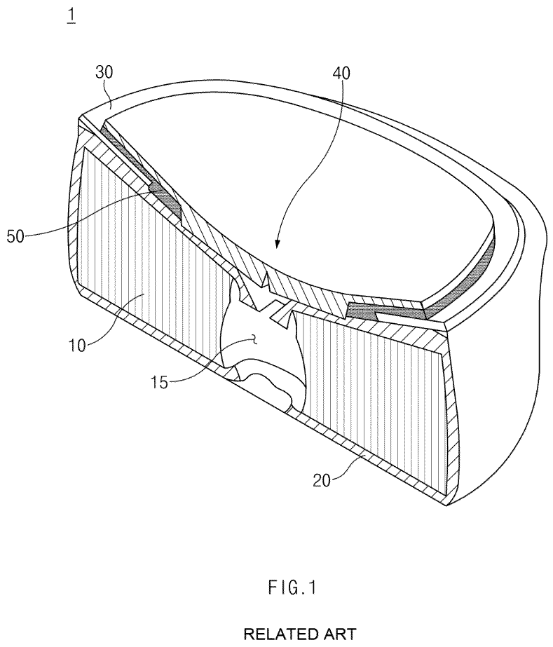

The electrode terminal 140 may be a terminal bonded to the through-hole 131 formed inside the base plate 130. The electrode terminal 140 may be a positive electrode terminal having a positive pole. This may be a result of the positive electrode of the electrode assembly 110 being connected to the electrode terminal 140. FIG. 1 illustrates a state in which an electrode tab 180 extending from the electrode is connected to a bottom surface of the electrode terminal 140. This bonding may be bonding using the welding.

When the electrode terminal 140 has the positive pole, each of the can body 120 and the base plate 130 may have a negative pole. The negative electrode of the electrode assembly 110 may be connected to the can body 120 so that the can body 120 has the negative pole. As the base plate 130 is welded to the can body 120, the same negative pole as the can body 120 may be formed. A negative electrode tab may be connected to the bottom surface of the can body 120.

At least a portion of the electrode terminal may be configured to be inserted into the through-hole 131 formed inside the base plate 130 so as to cover the through-hole 131. The electrode terminal 140 may be made of a metal material, and the metal material may be any one or more selected from SUS, nickel-plated carbon steel, and Al. The electrode terminal 140 may be configured to be connected to the electrode 111 of the electrode assembly 110 through the electrode tab 180 and may be a portion forming a terminal through which the battery is connected to an external device.

The insulating gasket 150 may be configured to insulate the electrode terminal 140 from the base plate 130. That is, the insulating gasket 140 may be configured to prevent short circuit from occurring between the electrode terminal 140 and the base plate 130. When the electrode terminal 140 has the positive pole, since the base plate 130 bonded to the body of the can body 120 that has a negative pole has a negative pole, and the electrode terminal 40 has a positive pole, a structure that insulates the electrode terminal 140 from the base plate is required. The structure may be an insulating gasket 150.

In addition, the electrode terminal 140, the insulating gasket 150, and the base plate 130 may be bonded to each other by thermal fusion. In the related art, a rivet structure is used to couple the electrode terminal 140. However, in the button-type secondary battery 100 according to Embodiment 1 of the present invention, a thermal fusion structure instead of the rivet structure may be used.

The insulating sheet 160 may be disposed on a bottom surface of the base plate 130 and may be configured to insulate a bottom surface of the base plate 130. The insulating sheet 160 may insulate the base plate 130 and the electrode tab 180 from each other. In addition, the insulating sheet 160 may insulate the base plate 130 and the electrode assembly 110 from each other.

In addition, the insulating sheet 160 may be attached to the bottom surface of the base plate 130. When attached as described above, the insulating sheet 160 may be stably disposed without moving.

In detail, in the button-type secondary battery 100 according to Embodiment 1 of the present invention, the electrode terminal 140 may include an insertion part 141 inserted into the through-hole 131 and a terminal plate part 142 extending outward from an upper end of the insertion part 141 and extending to have a plate shape.

In this case, the insertion part 141 may have a shape of which a diameter gradually increases in a direction closer to the electrode assembly 110. That is, a cross-sectional diameter of the insertion part 141 may gradually increase as the insertion part 141 descends in a direction closer to the electrode assembly 110. An insertion hole 161 may be formed inside the insulating sheet 160. In this case, a lower end of the insertion part 141 may be inserted into the insertion hole 161 by passing through the insertion hole 161 of the insulating sheet 160. When having such a structure, the lower end of the insertion part 141 may not be in contact with the insulating sheet 160. That is, the lower end of the insertion part 141 may not touch or press the insulating sheet 160.

In addition, the button-type secondary battery 100 according to Embodiment 1 of the present invention may include an electrode tab 164 extending from the electrode 111 of the electrode assembly 110. The electrode tab 180 may extend from the electrode 111 of the electrode assembly 110 so as to be in contact with the electrode terminal 140. The electrode tab 180 may be a positive electrode tab. In this case, the electrode tab 180 may extend from the positive electrode of the electrode assembly 110 so as to be in contact with the electrode terminal 140.

In the button-type secondary battery 100 according to Embodiment 1 of the present invention, a central hole 115 may be defined at a winding center of the electrode assembly 110. In addition, a diameter d1 of a bottom surface of the insertion part 141 may be greater than a diameter d2 of the central hole 115. In addition, the diameter of the insertion part 141 may gradually increase in a direction closer to the electrode assembly 110. With reference to FIG. 2, the diameter of the insertion part 141 may gradually increase in a downward direction. As an example of such a configuration, a cross-section (longitudinal cross-section) of the insertion part 141 may have a trapezoidal shape. With reference to FIG. 2 (the trapezoidal shape is illustrated in FIG. 2), a lower side of the trapezoidal shape may be longer than an upper side of the trapezoidal shape.

When the insertion part 141 is defined in a shape in which the diameter of the insertion part 141 gradually increases in the downward direction, a central portion and a peripheral portion of the electrode assembly 110 may not be deformed or collapsed even when the external force or an external impact occurs, or a degree of the deformation of the electrode assembly 110 may be reduced.

In the same manner as in FIG. 1, when the electrode terminal 140 is collapsed or deformed downward, the insertion part 141 of the electrode terminal 140 may press a top surface of the electrode assembly 110. Here, as a width of the bottom surface of the insertion part 141 becomes wider, the insertion part 141 may press the top surface of the electrode assembly 110 at a lower pressure. That is, since the pressure is a value obtained by dividing the magnitude of the external force by an area of the bottom surface of the insertion part 141, when the magnitude of the external force is the same, as the area of the bottom surface of the insertion part 141 increases, the pressure applied to the electrode assembly 110 may be reduced. This may be similar to the principle that eggs are not broken when a board is placed on a large number of regularly arranged eggs, and then a person climbs on the board.

In addition, the bottom surface of the insertion part 141 may be larger than the size of the central hole 115, and thus, the insertion part 141 may have the bottom surface that is sufficiently large completely cover the central hole based on a plan view. In this case, based on the plan view, an area occupied by the central hole 115 may be disposed within the area occupied by the bottom surface of the insertion part 141.

The diameter d1 of the bottom surface of the insertion part 141 may be greater than or equal to 0.5 times the diameter d0 of the electrode assembly 110. The bottom surface of the insertion part 141 may be provided in a circular shape, and in this case, the more the diameter of the bottom surface of the insertion part 141 increases, the more the pressure applied to the electrode assembly 110 by the insertion part 141 when the electrode terminal 140 is collapsed may be reduced. In addition, the diameter of the bottom surface of the insertion part 141 may be less than or equal to one time of the diameter d0 of the electrode assembly 110. That is, the diameter of the bottom surface of the insertion part 141 may be the same as the diameter of the electrode assembly 110 or less than the diameter of the electrode assembly 110 when compared with the diameter of the electrode assembly 110. When the diameter d1 of the bottom surface of the insertion part 141 is greater than the diameter d0 of the electrode assembly 110, an unnecessary empty space may be generated, and thus, it may not be efficient in terms of energy density.

Due to the configuration described above, the button-type secondary battery 100 according to Embodiment 1 of the present invention may prevent or minimize the damage and deformation of the electrode assembly 110 inside the cell, which may occur due to the impact and vibration outside the cell. Alternatively, a range of the collapse or deformation of the electrode assembly may be minimized.

### Embodiment 2

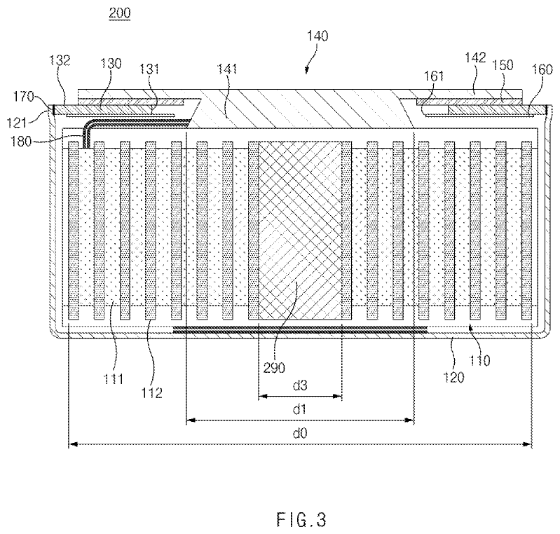

FIG. 3 is a cross-sectional view of a button-type secondary battery according to Embodiment 2 of the present invention.

Embodiment 2 of the present invention is different from Embodiment 1 in that a center pin 290 is inserted into a central hole 115 of an electrode assembly 110.

The contents that are duplicated with Embodiment 1 will be omitted as much as possible, and Embodiment 2 will be described with a focus on the differences. That is, it is obvious that contents that are not described in Embodiment 2 may be regarded as the contents of Embodiment 1 if necessary.

With reference to FIG. 3, in a button-type secondary battery 200 according to Embodiment 2 of the present invention, a center pin 290 filled in a central hole 115 is provided in the central hole 115. The center pin 290 may be at least partially filled in the central hole 115 and may also be completely filled in the central hole 115. When the center pin 290 is filled in the central hole 115 of the electrode assembly 110, the central hole 115 may be prevented from being collapsed or deformed, and when the center pin 290 is completely filled in the central hole of the electrode assembly 110, the central hole 115 of the electrode assembly 110 may be more reliably prevented from being collapsed or deformed.

Since the center pin 290 is present in the central hole 115 in the button-type secondary battery 200 according to Embodiment 2 of the present invention, when an electrode terminal 140 is collapsed or deformed downward due to external force or an external impact, the insertion part 141 may be in contact with a top surface of the center pin 290 and thus be supported by the center pin 290. That is, the electrode terminal 140 may be prevented from descending by applying supporting force while the top surface of the center pin 290 supports a bottom surface of the insertion part 141. Thus, the damage and deformation of the electrode assembly 110 inside a button cell, which may occur by an impact and vibration, may be significantly effectively prevented or minimized.

Specifically, in the button-type secondary battery according to Embodiment 2 of the present invention, a diameter d1 of a bottom surface of the insertion part 141 may be greater than a diameter d3 of the center pin 290. In addition, based on the plan view, an area occupied by the center pin 290 may be disposed within an area occupied by the bottom surface of the insertion part. In this case, even if the electrode terminal 140 is collapsed or deformed downward, the bottom surface of the insertion part may be significantly stably supported by the center pin. Thus, the damage or deformation of the electrode assembly may be prevented or minimized.

The diameter d1 of the bottom surface of the insertion part may be three times the diameter d3 of the center pin or greater. The bottom surface of the insertion part may be provided in a circular shape, and in this case, as the diameter d1 of the bottom surface of the insertion part is three or more times the diameter of the center pin d3, the pressure applied to the electrode assembly 110 by the insertion part 141 when the electrode terminal 140 is collapsed may be significantly reduced.

However, the diameter d1 of the bottom surface of the insertion part may be the same as the diameter d0 of the electrode assembly or be less than the diameter d0 of the electrode assembly when compared to the diameter d0 of the electrode assembly. When the diameter d1 of the bottom surface of the insertion part is greater than the diameter d0 of the electrode assembly, an unnecessary empty space may be generated, and thus, it may not be efficient in terms of energy density.

The center pin 290 may extend to be sufficiently elongated in a longitudinal direction of the central hole 115 to perform the reliable and effective supporting. Specifically, the top surface of the center pin 290 may be the same as or higher than the top surface of the electrode assembly 110, and the bottom surface of the center pin 290 may be the same or lower than the bottom surface of the electrode assembly 110. In addition, the center pin 290 may extend longer so that the bottom surface of the center pin 290 is in contact with a bottom surface of a can body 120.

While the example embodiments of the present invention have been described with reference to the specific example embodiments, it will be apparent to those skilled in the art that various changes and modifications may be made without departing from the spirit and scope of the invention as defined in the following claims.

### DESCRIPTION OF THE SYMBOLS

100: Button-type secondary battery
110: Electrode assembly
111: Electrode
112: Separator
115: Central hole
120: Can body
121: Opening of can body
130: Base plate
131: Through-hole
132: Edge of base plate
140: Electrode terminal
141: Insertion part
142: Terminal plate part
150: Insulating gasket
160: Insulating sheet
161: Insertion hole
170: Welding part
180: Electrode tab
290: Center pin

1. A button-type secondary battery having a diameter greater than a height thereof, the button-type secondary battery comprising:
a jelly roll-type electrode assembly in which electrodes and separators are wound;
a can body housing the electrode assembly;
a base plate including a through-hole and covering an opening at an upper end of the can body, and is the base plate being bonded to the can body;
an electrode terminal covering the through-hole of the base plate, at least a portion of the electrode terminal being inserted into the through-hole of the base plate;
an insulating gasket configured to insulate the electrode terminal and the base plate from each other; and
an insulating sheet disposed on a bottom surface of the base plate to insulate the bottom surface of the base plate,
wherein the electrode terminal comprises:
an insertion part inserted into the through-hole of the base plate; and
a terminal plate part extending outward from an upper end of the insertion part and having a plate shape,
wherein the insertion part has a diameter that gradually increases in a direction toward the electrode assembly.

2. The button-type secondary battery of claim 1, wherein an edge of the base plate and the upper end of the can body are bonded to each other by laser welding.

3. The button-type secondary battery of claim 1, wherein the electrode terminal, the insulating gasket, and the base plate are bonded to each other through thermal fusion.

4. The button-type secondary battery of claim 1, wherein the insulating sheet is attached to the bottom surface of the base plate.

5. The button-type secondary battery of claim 1, wherein:
a central hole is defined in a winding center of the electrode assembly, and
a bottom surface of the insertion part of the electrode terminal has a diameter greater than a diameter of the central hole.

6. The button-type secondary battery of claim 1, wherein:
a cross-section of the insertion part of the electrode terminal has a trapezoidal shape, and
the trapezoidal shape has a lower side longer than an upper side thereof.

7. The button-type secondary battery of claim 1, wherein, in a plan view, an area occupied by the central hole is disposed within of an area occupied by a bottom surface of the insertion part of the electrode terminal.

8. The button-type secondary battery of claim 1, wherein a diameter of a bottom surface of the insertion part of the electrode terminal is greater than or equal to 0.5 times a diameter of the electrode assembly and less than or equal to the diameter of the electrode assembly.

9. The button-type secondary battery of claim 1, wherein:
the insulating sheet has an insertion hole therein, and
the insertion part of the electrode terminal passes through the insertion hole of the insulating sheet.

10. The button-type secondary battery of claim 5, further comprising a center pin disposed in the central hole.

11. The button-type secondary battery of claim 10, wherein a diameter of the bottom surface of the insertion part of the electrode terminal is greater than a diameter of the center pin.

12. The button-type secondary battery of claim 10, wherein, in a plan view, an area occupied by the center pin is disposed within an area occupied by the bottom surface of the insertion part of the electrode terminal.

13. The button-type secondary battery of claim 10, wherein the bottom surface of the insertion part of the electrode terminal has a diameter which is three or more times a diameter of the center pin and is equal to or less than a diameter of the electrode assembly.

14. The button-type secondary battery of claim 1, wherein:
the electrode terminal has a positive polarity, and
each of the can body and the base plate has a negative polarity.
